(19) United States
(12) Patent Application Publication
(10) Pub. No.: US 2011/0045381 A1
(43) Pub. Date: Feb. 24, 2011

(54) Hydrocarbon PEM Membranes with Perfluorosulfonic Acid Groups for Automotive Fuel Cells

(75) Inventors: Timothy J. Fuller, Pittsford, NY (US); Michael R. Schoeneweiss, West Henrietta, NY (US); Sean M. MacKinnon, Fairport, NY (US); Frank Coms, Fairport, NY (US)

Correspondence Address: Brooks Kushman P.C., 1000 Town Center, Twenty-Second Floor, Southfield, MI, 48075-1238, US

(73) Assignee: GM GLOBAL TECHNOLOGY OPERATIONS, INC., Detroit, MI (US)

(21) Appl. No.: 12/542,900

(22) Filed: Aug. 18, 2009

(51) Int. Cl. H01M 8/10

(52) U.S. Cl. 429/483

(57) ABSTRACT

A solid electrochemical cell membrane composition comprises a hydrocarbon polymeric main chain and a perfluorinated superacid side group. A method of producing the membrane composition is also disclosed.

### TECHNICAL FIELD

The field to which the disclosure generally relates includes fuel cell membranes, products made therefrom and methods of making and using the same.

### BACKGROUND

Electrochemical cells, such as rechargeable batteries and fuel cells, are becoming important energy devices in the electronics and automotive industries. Polymer electrolyte fuel cells that use hydrogen gas as the fuel draw special attention due to their high energy efficiency, extremely low emissions, and demonstrated long life. The polymer electrolyte membrane used in the fuel cell provides the necessary ionically conductive connection between the anode and cathode. In order to obtain high power density, small size, light weight, and long service life, a cell membrane needs to have high ionic conductivity and stable mechanical properties over a wide range of temperature and humidity conditions.

In a hydrogen fuel cell, water management in the membrane is critical for efficient performance. The fuel cell must operate under conditions where the by-product water does not evaporate faster than it is produced because the membrane must be hydrated to maintain acceptable proton conductivity. That is, a significant hydration level of the cell membrane needs to be maintained.

To increase electric current of a hydrogen fuel cell, one commonly uses catalysts, high surface area electrodes and high operating temperature. Designing a polymer electrolyte membrane for use at high operating temperatures and low hydration levels has presented a challenge in developing commercially acceptable fuel cells.

### SUMMARY OF EXEMPLARY EMBODIMENTS OF THE INVENTION

One embodiment of the invention includes an electrochemical cell membrane composition comprising a hydrocarbon polymer main chain and a perfluorinated superacid side group covalently attached to the polymeric main chain.

Another embodiment of the invention includes a fuel cell comprising an anode, a cathode, and a membrane between the anode and the cathode, wherein the membrane comprises a polymer having a hydrocarbon polymeric main chain and a perfluorinated superacid side group covalently attached to the polymeric main chain.

Another embodiment of the invention includes a method of producing a fuel cell membrane composition, wherein the method comprises providing a hydrocarbon polymer and a perfluorinated superacid compound having a reactive group, and contacting or mixing the hydrocarbon polymer with the perfluorinated superacid compound to cause a coupling reaction or a graft polymerization that results in covalent attachment of the perfluorinated superacid to the hydrocarbon polymer.

Other exemplary embodiments of the invention will become apparent from the detailed description provided hereinafter. It should be understood that the detailed description and specific examples, while disclosing exemplary embodiments of the invention, are intended for purposes of illustration only and are not intended to limit the scope of the invention.

### BRIEF DESCRIPTION OF THE DRAWINGS

Exemplary embodiments of the present invention will become more fully understood from the detailed description and the accompanying drawings, wherein:

FIG. 1 provides a schematic illustration of a fuel cell incorporating the polymers of an embodiment of the present invention; and

FIG. 2 is an illustration of FTIR spectra of various reactants and polymer products.

### DETAILED DESCRIPTION OF EXEMPLARY EMBODIMENTS

Reference will now be made in detail to presently preferred compositions, embodiments and methods of the present invention, which constitute the best modes of practicing the invention presently known to the inventors. The figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the term “polymer” includes “oligomer,” “copolymer,” “terpolymer,” “block,” “random,” “segmented block,” and the like; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

Throughout this application, where publications are referenced, the disclosures of these publications in their entireties are hereby incorporated by reference into this application to more fully describe the state of the art to which this invention pertains.

The following description of the embodiment(s) is merely exemplary in nature and is in no way intended to limit the invention, its application, or uses.

The term “block” as used herein means a portion of a macromolecule, comprising many constitutional units, that has at least one feature that is not present in adjacent portions.

The term “block macromolecule” as used herein means a macromolecule that is composed of blocks in linear sequence.

The term “block polymer” as used herein means a substance composed of block macromolecules.

The term “block copolymer” as used herein means a polymer in which adjacent blocks are constitutionally different, i.e., each of these blocks comprise constitutional units derived from different characteristic species of monomer or with different composition or sequence distribution of constitutional units.

The term “random copolymer” as used herein means a copolymer consisting of macromolecules in which the probability of finding a given repeating unit at any given site in the chain is independent of the nature of the adjacent units.

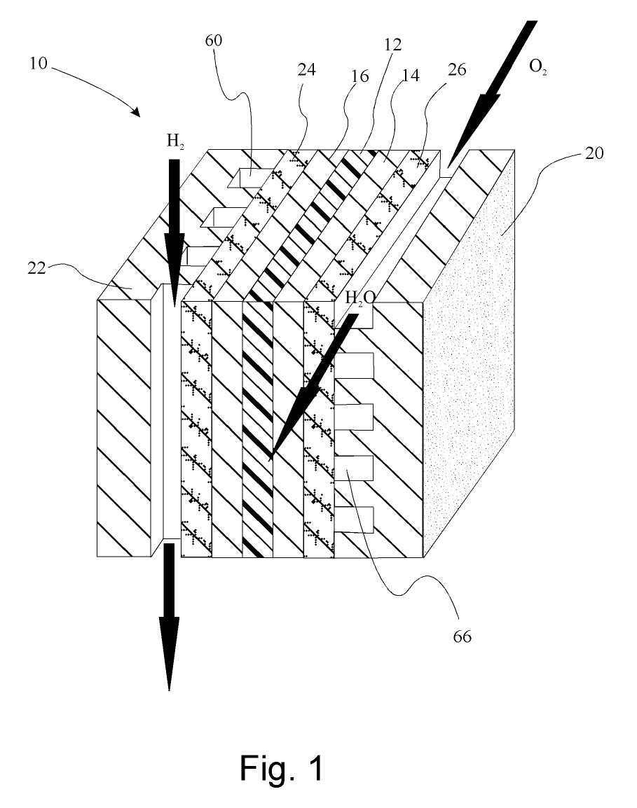

With reference to FIG. 1, an exemplary fuel cell 10 that incorporates a polymer electrolyte membrane including polymers from the invention is provided. The illustrated PEM fuel cell 10 includes a polymeric ion conductive membrane 12 disposed between a cathode catalyst layer 14 and an anode catalyst layer 16. The polymeric ion conductive membrane 12 includes one or more of the polymers set forth below. The illustrated fuel cell 10 also includes conductive plates 20, 22, gas channels 60 and 66, and gas diffusion layers 24 and 26.

In one embodiment, the invention includes a membrane composition comprising a hydrocarbon polymeric main chain and a perfluorinated superacid side group to be incorporated into the polymeric ion conductive membrane 12. The perfluorinated superacid side group is covalently attached to the polymeric main chain. The perfluorinated superacid side group provides high ionic conductivity even at low hydration levels. The hydrocarbon polymer main chain provides the desired physical properties at low cost. This membrane composition has high ionic conductivity and desirable film properties at low hydration levels and high operating temperatures.

The hydrocarbon polymeric main chain is the main chain structure of a polymer made of carbon, hydrogen, and optional other elements such as oxygen, nitrogen, sulfur, phosphorus, chlorine, and bromine. In one embodiment, the hydrocarbon polymer is substantially free of fluorine. Hydrocarbon polymers suitable for this invention include those polymers with groups that are reactive towards radicals of, which includes but are not limited to, polyolefins, poly(1,2-butadiene), poly(1,4-butadiene), polystyrene, phenolic polymers, polydivinylstyrene, polyvinyl chloride, polyvinylidene chloride, polyesters, ethylene-propylene-diene-monomer polymers (EPDM), polyacrylamide, polyvinyldene fluoride containing polymers, which have unsaturated moieties that are reactive towards radicals. Other polymers with C—H bonds that can form radicals, which in turn can react with other radicals by radical coupling reactions can also be used. Hydrocarbon polymers can be linear, branched, hyperbranched or crosslinked in terms of their polymer architecture. Hydrocarbon polymers such as those listed above are less expensive than fluorinated polymers, such as NAFION®, available from DuPont. Hydrocarbon polymers can also be easily made into thin and strong membranes that adhere well to the anode and cathode materials.

In one embodiment, the hydrocarbon polymer has at least one reactive group that can participate in a graft polymerization and/or a coupling reaction to allow covalent attachment of a side group. Such a reactive group includes, but is not limited to, vinyl, vinyl ether, perfluorovinyl ether, perfluorovinyl, acrylate, methacrylate, allyl, chloro, bromo, iodo, ester, phenolic, hydroxyl amide, carboxyl, perfluorovinyl, perfluoroacrylate, perfluoromethacrylate, and trifluoromethylacrylate.

A perfluorinated superacid is a strong acid that can provide ionic conductivity even at low hydration levels. A reactive perfluorinated superacid is used to react with a hydrocarbon polymer to form the membrane composition. In one embodiment, the reactive perfluorinated superacid is represented by the formula: Z—R_{f}—SOₙX, where Z is a reactive radical capable of reacting with and chemically attaching to a hydrocarbon polymer described above, R_{f} is a perfluorinated radical, n is the number 2 or 3, and X is an element selected from the group consisting of hydrogen, fluorine, chlorine, sodium, potassium, lithium, magnesium, and combinations thereof. Reactive group Z may include, but is not limited to, at least one of a vinyl, fluorinated vinyl, acrylate, methacrylate, styryl, epoxy, and halogen.

In at least one embodiment, a vinyl group is included in the perfluorinated superacid. A graft polymerization of the vinyl group containing perfluorinated superacid may be carried out in the presence of a hydrocarbon polymer and a free radical initiator to covalently attach the perfluorinated superacid to the hydrocarbon polymer. In another embodiment, the perfluorinated superacid is a sulfonic acid represented by the formula: Z—R_{f}—SO₃H, or a salt thereof. In yet another embodiment, the perfluorinated superacid may be a halosulfonic acid represented by the formula: Z—R_{f}—SO₂X, where X is element chlorine or fluorine and R_{f} is a perfluorinated radical. Perfluorinated radical R_{f} may include, but is not limited to, radicals of perfluorinated ethylene, represented by the formula: —CF₂—CF₂—, perfluorinated propylene represented by the formula: —CF₂—CF(CF₃)—, perfluorinated ethylene oxide represented by the formula: —O—CF₂—CF₂—, perfluorinated propylene oxide represented by the formula: —O—CF(CF₃)—CF₂—, and any combinations or polymeric forms of the above. R_{f} may also be perfluorinated olefins, perfluoroethers, and perfluorinated cyclic or aromatic radicals.

In illustrative embodiments, the perfluorinated superacid may be attached to a hydrocarbon main chain polymer through a coupling reaction or a graft polymerization reaction. Coupling reactions includes addition, condensation, radical coupling and displacement reactions, copper coupling, nickel coupling, and the like, that result in the formation of a chemical bond linking the superacid group to a hydrocarbon main chain polymer. Graft polymerization involves the polymerization of the perfluorinated superacid and grafting of the polymerized perfluorinated superacid to the hydrocarbon main chain polymer. Graft polymerization can be initiated by any suitable manner, such as by a free radical initiator, such as benzoyl peroxide (BPO) and AIBN (azobisisobutyronitrile), or by high energy radiations such as ultraviolet light, electron beam, gamma ray and plasma.

In one embodiment, a hydrocarbon polymer, poly(1,2-butadiene), is allowed to react with a perfluorinated superacid represented by the formula: ICF₂CF₂OCF₂CF₂SO₂F, in the presence of benzoyl peroxide as a free radical initiator. A free radical coupling reaction takes place, resulting in the formation of a hydrocarbon polymer having at least one fluorinated superacid side group. Such reaction is illustrated by the following:

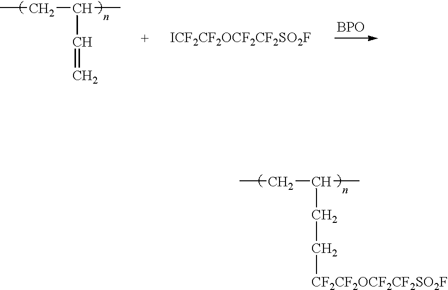

where n represents the degree of polymerization of poly(1,2-butadiene).

In another embodiment, a hydrocarbon polymer, poly(1,2-butadiene), is allowed to react with a vinyl perfluorinated superacid, perfluoro(2-(2-fluorosulfonylethoxy)propyl vinyl ether), represented by the formula: CF₂═CFOCF₂C(CF₃)OCF₂CF₂SO₂F in the presence of the free radical initiator benzoyl peroxide. A polymeric vinyl perfluorinated superacid is thus grafted to the poly(1,2-butadiene) main chain through the graft polymerization reaction. The reaction is illustrated by the following:

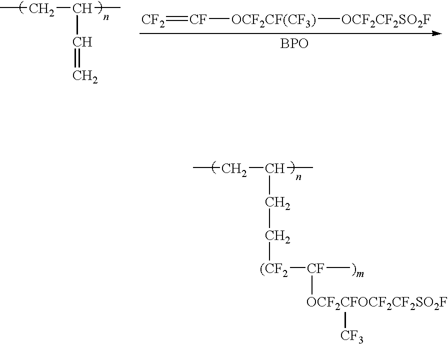

where n represents the degree of polymerization of poly(1,2-butadiene) and m is a positive integer ≧1. Other derivatives and attachment arrangements of perfluorinated superacid side groups are also possible through such graft polymerization.

Additionally, the above coupling and grafting reactions can be carried out in the presence of a sufficient amount of free radical initiator to cause crosslinking of poly(1,2-butadiene) through free radical coupling between different poly(1,2-butadiene) chains. Crosslinking can improve the mechanical and thermal properties of the membrane composition. Alternatively, a perfluorinated superacid having more than one reactive group per molecule, and/or an additional crosslinking agent can be used to react with a hydrocarbon polymer to form a crosslinked polymer. Crosslinking of the poly(1,2-butadiene) can be carried out by sulfur vulcanization as is known in the rubber tire industry, and by free radical initiators, e.g., dicumyl peroxide and others.

In at least one variation, the perfluorinated superacid side group may be present in the membrane composition at the amount of 0.1 to 2.84 meq/g of membrane composition, and in yet another variation between 0.5 to 2.0 meq/g of membrane composition. In yet another variation, the perfluorinated superacid side group includes SO₃H, which may be present in the membrane composition in the amount of 1 to 2 meq SO₃H per gram of membrane composition, and in yet another variation at the amount of 1.25 to 1.75 meq SO₃H per gram of membrane composition. Such perfluorinated superacid content can be achieved by controlling the ratio of perfluorinated superacid to hydrocarbon polymer in the coupling reaction or grafting polymerization. Sufficient amounts of perfluorinated superacid side group is necessary to maintain a high ionic conductivity of such membrane composition, especially at low hydration levels. In at least one variation, the hydration level of the membrane composition may be more than 0.6 meq water per gram of membrane composition.

The reaction can be carried out in a homogeneous solution or in a heterogeneous mixture. In one embodiment, the reaction between the hydrocarbon polymer and perfluorinated superacid is carried out by dissolving both of the materials in a common solvent (or a mixture of solvents) to form a homogeneous solution. The reaction takes place in the solution in the presence of a free radical initiator or a catalyst. After the reaction reaches the desired conversion, the reaction product is then isolated and optionally purified from the solution. In another embodiment, the hydrocarbon polymer is first made into a thin film. The film is then brought into contact with a perfluorinated superacid. The perfluorinated superacid is allowed to permeate into the film without dissolving the film. A coupling reaction or a graft polymerization between the perfluorinated superacid and the hydrocarbon polymer is then carried out in such a heterogeneous mixture in the presence of a free radical initiator or a catalyst. Optionally, the reacted film is soaked or rinsed in a clean solvent to remove undesired by-products and/or unreacted compounds.

In illustrative embodiments, the composition of hydrocarbon polymer main chain with a perfluorinated superacid side group is suitable as a membrane material for electrochemical cells, such as rechargeable batteries and fuel cells. The composition can be made into a thin membrane by solution casting, extrusion, melt-blown or other suitable film formation techniques known to one of ordinary skill in the art. The film can then be laminated, glued, or simply sandwiched between an anode and a cathode to form an electrochemical cell. Alternatively, the composition can be applied directly to an electrode surface, without pre-forming into a film, by coating, painting, extrusion, and other similar methods known to one of ordinary skill in the art. The composition can be used alone or as one component in a blend with other membrane materials such as ethylene-tetrafluoroethylene copolymer.

With a hydrocarbon polymer main chain, the membrane composition has good solubility in common solvents. It is therefore easier for one to form a thin and adherent membrane on an electrode surface. Solubility in common solvents also affords easy incorporation of other components onto or into such membrane. Other components that can be incorporated into such membranes include catalysts, stabilizers, hydrogen peroxide scavengers and stabilizers. Suitable exemplary additives include particulate and preferably nanopaticle metal oxides like ceria (CeO₂), manganese dioxide (MnO₂), Ce/ZrO₂, and additives consistent with those discussed in U.S. 2008/0166620, which is incorporated herein by reference in its entirety.

The membrane composition exhibits high ionic conductivity even at relatively low hydration levels and at elevated temperatures. Each sulfonic acid group attracts a solvation sphere of water, and the number of water molecules per sulfonic acid group is typically referred to as lambda, λ. Water uptake by the membrane on a weight basis is determined as a function of relative humidity and temperature. The moles of water absorbed by the membrane (as determined by a gravimetric weight increase and divided by 18 grams of water per mole) is the number of moles of water absorbed. This value of the number of moles of water absorbed is divided by the number of moles of sulfonic acid groups per the same weight of membrane, as determined by titration of the acid groups with 0.0100 normal sodium hydroxide. This is a physical measure of lambda. The hydration level of the membrane composition can be controlled by humidification to specific inlet relative humidity on the anode and cathode sides. Suitable hydration level is between 30 and 150% relative humidity and preferably fuel cell operation is at as low a relative humidity as possible to prevent parasitic loads from humidifiers and compressors.

In at least certain embodiments, fuel cell operation at 50% relative humidity at gas inlets is preferred. The composition exhibits sufficient ionic conductivity at temperatures ranging from subfreezing conditions (of less than 0° C.) to around 100° C. The high operating temperatures of a fuel cell having such membrane composition allow faster electrochemical reactions, and thus desirable high electric current. Moreover, heat exchange between the fuel cell and air at operating temperatures of greater than 100° C., will allow the use of radiators with the same dimensions as those presently being used in automobiles. However, the membrane according to the invention may be used in fuel cells operating at temperatures primarily below 120° C.

The membranes are evaluated with a relative humidity sweep profile under the following conditions. Membranes are evaluated with catalyst coated diffusion media: Specifically, membranes are screened in fuel cells and performance is then summarized in polarization curves in which cell voltage (in volts) is plotted versus current density (in Amps/cm²) under the following conditions: 150% relative humidity (R.H.) out: 2/2(ANC) stoic; 100/50% (A/C) inlet R.H.; 80° C.; 170 kPa gauge; 110% relative humidity (R.H.) out: 2/2(ANC) stoic; 100/50% (A/C) inlet R.H.; 80° C.; 50 kPa gauge; 85% relative humidity (R.H.) out: 3/3(ANC) stoic; 50/50% (A/C) inlet R.H.; 80° C.; 75 kPa gauge; 80% relative humidity (R.H.) out: 2/2(A/C) stoic; 35/35% (A/C) inlet R.H.; 80° C.; 50 kPa gauge; 63% relative humidity (R.H.) out: 3/3(ANC) stoic; 32/32% (A/C) inlet R.H.; 80° C.; 50 kPa gauge; where (A/C) refers to anode/cathode. When polarization curves are obtained where the current density runs out to 1.2 A/cm² with reasonable voltage (usually greater than 0.4V), the membranes are said to “run every condition.” The membrane composition of this invention can operate at both low hydration level near 50% relative humidity, at the anode and cathode inlets, and high operating temperature, such as at around 120° C. with sufficient ionic conductivity.

A fuel cell can be constructed using the membrane composition set forth. In one embodiment, a fuel cell is constructed using this membrane composition according to the method disclosed in U.S. Patent Application Publication No. US 2005/0271929A1, which is incorporated here by reference in its entirety.

### EXAMPLE 1

### Reaction of Poly(1,2-butadiene) with ICF₂CF₂OCF₂CF₂SO₂F.

Under argon atmosphere and with mechanical stirring, the following reaction mixture is maintained at 60° C. for 16 hours:

JSR 810, syndiotactic-poly(1,2-butadiene) (Japanese Synthetic Rubber Company) 0.5 to 1 g, 1:1 mixture of benzene (12.5 mL) and hexafluorobenzene (12.5 mL) as solvent, benzoyl peroxide (free radical initiator) 1 g and ICF₂CF₂OCF₂CF₂SO₂F (reactive superacid precursor, from Aldrich) 4.75 g.

After reaction, the above mixture is treated with potassium hydroxide before addition to methanol to precipitate out a white polymer product. The polymer product is washed extensively with water, isolated by filtration and dried. After being treated with 2N sulfuric acid, extensive washing in water, filtration and drying, a 0.02 gram sample of the polymer product is added to 50-mL of water containing 1 gram of sodium chloride and the acidic solution is titrated to a pH 7 end-point with standard 0.0100 normal sodium hydroxide solution. The sulfonic superacid concentration of the polymer product is determined to be 0.9 meq SO₃H/g of polymer by the titration method.

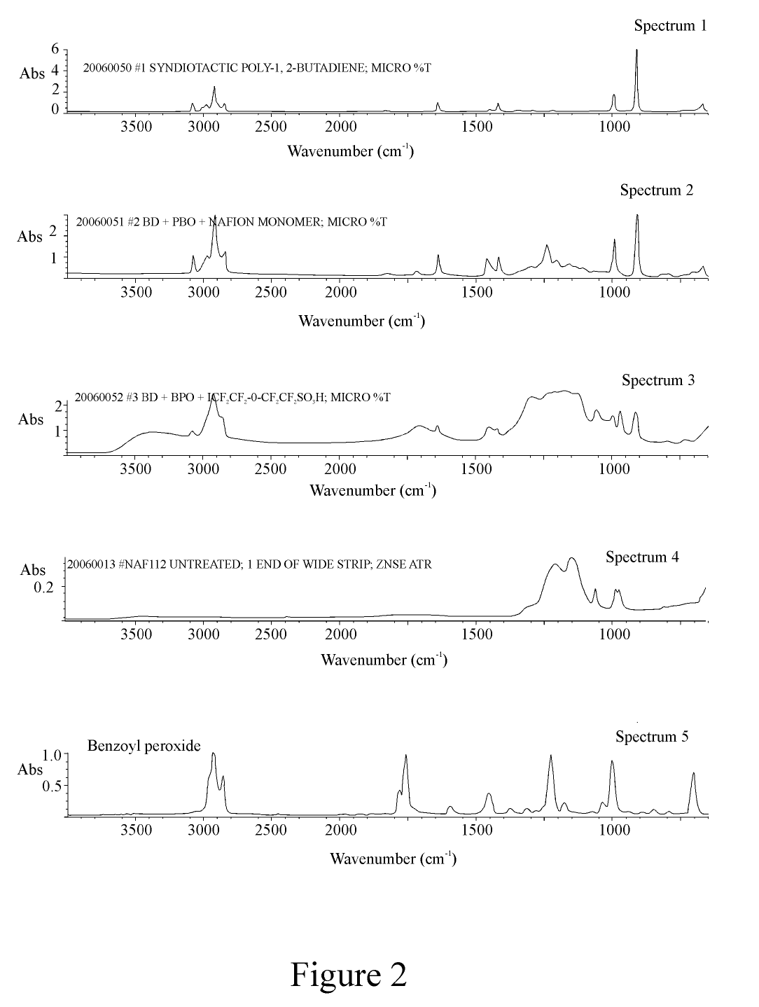

Infrared spectra of the reactants and the polymer product are shown in FIG. 2. The polymer product exhibits the features of both the poly(1,2-butadiene) and perfluorinated superacid, indicating the formation of a composition comprising poly(1,2-butadiene) main chain with a perfluorinated sulfonic superacid side group.

The solid product that is obtained is treated with sodium chloride (1 g for each 0.02 grams of resin solid) in water (50 mL for each 0.1 gram of solid) and with 50 wt. % sodium hydroxide until the pH is greater than 7. The amount of ion exchangeable protons on the polymer is 0.9 milliequivalents of SO₃H/g of polymer.

The dry, brown polymer product (0.8 grams) is then compression molded into a membrane between Teflon film at 2,000 pounds on a 5-inch by 5-inch platen at 350° F. The film is immersed in a glass dish with 1 liter of water containing 0.009 milli-moles of Ce³⁺ ions (from cerium (III) sulfate) per gram of film. The resultant film is used as a polyelectrolyte membrane and has properties that are similar to Nafion® 1100 membrane (E.I. DuPont de Nemours).

### EXAMPLE 2

### Reaction of Poly(1,2-butadiene) with CF₂═CF—OCF₂CF(CF₃)—O—CF₂CF₂—SO₂F.

Under argon atmosphere and with mechanical stirring, the following reaction mixture is maintained at 60° C. for 16 hours to carry out a graft polymerization:

JSR 810, syndiotactic-poly(1,2-butadiene) (Japanese Synthetic Rubber Company) 0.5 to 1 g, mixture of benzene (12.5 mL) and hexafluorobenzene (12.5 mL) as solvent, benzoyl peroxide (free radical initiator) 1 g, and CF₂═CFOCF₂C(CF₃)OCF₂CF₂SO₂F (reactive superacid precursor, from Aldrich) 4.75 g.

After graft polymerization, the reaction mixture is treated with potassium hydroxide before addition to methanol to precipitate out a white polymer product. The polymer product is washed extensively with water, isolated by filtration and dried. The dried polymer is further treated with potassium hydroxide, washed with water and finally washed in 2N sulfuric acid.

Infrared spectra of the reactants and the polymer product are shown in FIG. 2. The polymer product exhibits the features of both the poly(1,2-butadiene) and perfluorinated superacid, indicating the formation of a composition comprising poly(1,2-butadiene) main chain and a perfluorinated sulfonic superacid side group.

FTIR Spectra shown in FIG. 2 illustrates Absorbance (1 divided by transmittance) plotted against infrared wavenumber. Spectrum 1 (top) is syndiotactic-poly-1,2-butadiene. Spectrum 2 is that of the product from the reaction of poly-1,2-butadiene with CF₂—CF—O—CF₂(CF₃)—OCF₂CF₂SO₂F in the presence of BPO (benzoyl peroxide). Spectrum 3 is that of the product from the reaction of syndiotactic-poly-1,2-butadiene with formula ICF₂CF₂OCF₂CF₂SO₂F in the presence of BPO (benzoyl peroxide). Spectrum 4 is that of Nafion® 1100 and is shown as a control. Spectrum 5 is that of benzoyl peroxide, which is a reagent used in the reactions described in Examples 1 and 2.

Micro % T stands for the % Transmittance of infrared light in the infrared experiment performed by micro-Fourier Transform Infrared Spectroscopy (FTIR) techniques. ABS stands for Absorbance, which is 1 divided by transmittance.

The Nafion® monomer is the vinyl fluorinated superacid in Example 2. It has the structure: CF₂═CF—O—CF₂CF(CF₃)—OCF₂CF₂SO₃H from the alkaline hydrolysis of CF₂=CF—O—CF₂CF(CF₃)—OCF₂CF₂SO₂F followed by an acid treatment with 2 normal sulfuric acid (the —SO₂F group hydrolyzes to the —SO₃⁻Metal+group in alkaline solution and is converted to —SO₃H after treatment with an acidic wash).

Spectrum 4 is that of a control sample of Nafion® 1100 and the infrared spectrum shows where the —SO₃H absorbance should be, with two absorbances, somewhere around 1150 and 1200 cm⁻¹, respectively. The FTIR (spectrum 2) shows that the product from the reaction of syndiotactic-poly(1,2-butadiene) with BPO and ICF₂CF₂OCF₂CF₂SO₂F (followed by alkaline hydrolysis and acidification of the SO₂F group) was successfully formed, and is consistent with the incorporation of —CF₂CF₂OCF₂CF₂SO₃H onto the polybutadiene polymer backbone (see spectrum 2). By contrast, spectrum 3 can be used to show that the attachment of CF₂═CFOCF₂CF(CF₃)OCF₂CF₂SO3H did not proceed as well as that of the product shown in spectrum 2. Spectrum 3 can be used to show that only a few of SO₃H groups were grafted onto the polybutadiene backbone.

What is claimed is:

1. An electrochemical cell membrane composition comprising a hydrocarbon polymer main chain and a perfluorinated superacid side group covalently attached to said polymeric main chain.

2. A fuel cell comprising a membrane composition as set forth in claim 1.

3. An electrochemical cell membrane composition of claim 1, wherein the perfluorinated superacid is present in the composition at 0.1 to 2.84 meq/g of membrane composition.

4. An electrochemical cell membrane composition of claim 1, wherein the hydrocarbon polymeric main chain comprises at least one of polyolefins, polystyrene, polyisoprene, polybutadiene, polyvinylchloride, polyvinylfluoride, polyvinylidene fluoride, polyacrylates, polymethacrylates, polychloroprene, polyacrylonitrile, or copolymers thereof.

5. An electrochemical cell membrane composition of claim 1, wherein the superacid has the following chemical formula: —R_{f}—SOₙX; where R_{f} is a perfluorinated radical, n is number 2 or 3, and X is an element selected from the group consisting of hydrogen, fluorine, chlorine, sodium, potassium, lithium, magnesium, and the combination thereof.

6. An electrochemical cell membrane composition of claim 5, wherein the perfluorinated radical comprises a perfluorinated olefin, a perfluoroether, or the combination thereof.

7. An electrochemical cell membrane composition of claim 1 comprising a product of a chemical reaction between the hydrocarbon polymer and the reactive compound having the perfluorinated superacid group.

8. An electrochemical cell membrane composition of claim 7, wherein the chemical reaction is a coupling reaction or a graft polymerization reaction.

9. An electrochemical cell membrane composition of claim 8, wherein the coupling reaction is an addition, displacement, radical coupling or condensation reaction.

10. An electrochemical cell membrane composition of claim 9, wherein the graft polymerization reaction is a free radical initiated polymerization.

11. An electrochemical cell membrane composition of claim 7, wherein the hydrocarbon polymer comprises at least one of polyolefins, polystyrene, polyisoprene, polybutadiene, polyvinylchloride, polyvinylfluoride, polyvinylidene fluoride, polyacrylates, polymethacrylates, polychloroprene, polyacrylonitrile, or copolymers thereof.

12. An electrochemical cell membrane composition of claim 7, wherein said reactive compound has a chemical structure represented by the formula:
Z—R_{f}—SOₙX,
where Z is a reactive radical capable of reacting and chemically attaching to said hydrocarbon polymer, R_{f} is a perfluorinated radical, n is number 2 or 3, and X is an element selected from the group consisting of hydrogen, fluorine, chlorine, sodium, potassium, lithium, magnesium, and the combination thereof.

13. An electrochemical cell membrane composition of claim 12, wherein Z is a halogen, a fluorinated vinyl group, or an iodine radical.

14. An electrochemical cell membrane composition of claim 12, wherein X is hydrogen, fluorine or chlorine.

15. An electrochemical cell membrane composition of claim 14, wherein n is 2 and X is fluorine.

16. A fuel cell comprising:
an anode;
a cathode; and
a membrane between said anode and cathode;
wherein the membrane comprises a polymer having a hydrocarbon polymeric main chain and a perfluorinated superacid side group covalently attached to said polymeric main chain.

17. A fuel cell of claim 16, wherein the superacid is present at about 0.1 to 2.84 meq/g of polymer.

18. A fuel cell of claim 17, wherein the superacid has a chemical structure represented by the formula: —R_{f}—SOₙX; where R_{f} is a perfluorinated radical, n is number 2 or 3, and X is an element selected from the group consisting of hydrogen, fluorine, chlorine, sodium, potassium, lithium, magnesium, and the combination thereof.

19. A fuel cell of claim 18, wherein the operating temperature of the fuel cell is at least 120° C. and the hydration level of said membrane is more than 0.6 millimoles of super-acid groups per gram of membrane.

20. A method of producing a fuel cell membrane composition comprising:
providing a hydrocarbon polymer;
providing a perfluorinated superacid compound having a reactive group; and
contacting or mixing the hydrocarbon polymer with the perfluorinated superacid compound to cause a coupling reaction or a graft polymerization that results in covalent attachment of the perfluorinated superacid to the hydrocarbon polymer.
